(19) United States
(12) Patent Application Publication
(10) Pub. No.: US 2005/0094021 A1
(43) Pub. Date: May 5, 2005

(54) Auto focus camera optical system

(76) Inventor: Demitry Gorlik, Rochester, NY (US)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(21) Appl. No.: 10/700,348

(22) Filed: Nov. 3, 2003

(51) Int. Cl. H04N 5/232

(52) U.S. Cl. 348/345

(57) ABSTRACT

An optical system in which an auto focus camera having an object plane is fitted with a close up lens. A structure, such as, a C-mount, is coupled to the close up lens and auto focus camera. The C-mount is capable of being coupled to an imaging optical system having an image plane so that the image plane of the imaging optical system is coincident with the object plane of the auto focus camera.

### BACKGROUND OF THE INVENTION

1. Field of the Invention

The present invention relates to an auto focus camera optical system, and more particularly to an auto focus camera optical system having automatic focus and zoom functionality that is useful in inspection systems, such as, electrical circuit inspection systems of various types.

2. Prior Art

Electrical circuit inspection systems of various types are known in the art, but they do

not include automatic focus and zoom functionalities. Magnifying video camera systems having automatic focus and zoom functionality are knows in the art. Conventionally, systems of this type employ microscopes having such functionality upstream of the eyepiece. Such microscopes are complicated and very expensive. As line widths in electrical circuits decrease with advancing manufacturing technology, the importance of fine focus in inspection systems increases accordingly. Although a system has been developed according to International PCT Application PCT WO 01/88592 A2 that provides an electrical circuit inspection system which provides zoom and/or automatic focus functionality and employs standard optical components, nevertheless, this system has the drawback that it cannot be combined easily with existing optical systems, such as CCTV objectives, video microscopes, video zoom microscopes, etc., and therefore, is of very limited applicability.

The idea of using close up lenses for the photography is not new. For many decades people have been using close up attachment lenses for making the pictures of small objects from short working distances. Standard photo camera objectives are usually designed to work from infinite working distance, and can be refocused to a certain relatively small (1 m-2 m) working distance. However, if the picture is to be made from a distance that is less than the minimum focusing distance, a close up lens is needed.

A close-up lens transfers the camera operational range from infinity to the working distance equal to its effective focal length. The magnification of such optical system is:
Mag.=F1/F2

### SUMMARY OF THE INVENTION

The idea of the invention is the provision of a structure that enables easy coupling of an AF camera with built-in lens to any imaging optical system, such as, CCTV objectives, video microscopes, video zoom microscopes, etc. The optical system is coupled to the AF camera with the close-up optics positioned in such a way that the object plane of the AF camera and the image plane of the optical imaging system coincide. The AF camera with the close up optics images the image plane of any optical system to which it is connected via a C-mount that is configure to achieve the condition stated above. Zoom capabilities of the camera can be used directly to magnify the image of the optical system. Also, the AF adjustment to the image plane position can be transferred to the object height adjustment of the optical system. The advantages of coupling the AF zoom camera to the imaging optical system, via the C-mount, are the AF adjustment capability of the object plane and additional zoom of the optical system. The mechanical design of the camera coupler includes the C-mount at one end and provides the possibility to be attached as a standard c-mount camera to optical devices.

### BRIEF DESCRIPTION OF THE DRAWINGS

FIG. 1 shows schematically an auto focus camera with a close up lens that has been used for photography.

FIG. 2 shows schematically an embodiment of the present invention.

FIG. 2a shows schematically an AF camera fitted with built in optics and a C-mount according to the invention.

FIG. 3 shows schematically another embodiment of the present invention.

FIG. 4 shows schematically still another embodiment of the present invention illustrating a CCTV lens refocusing from infinity to a limited working distance.

FIG. 5 is a schematic representation of an electrical circuit inspection station.

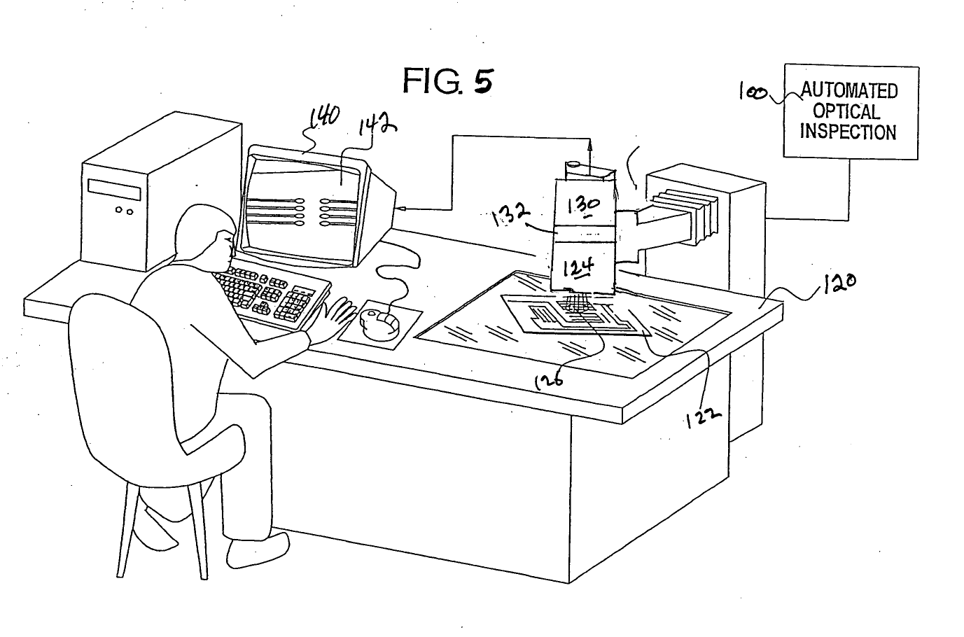

### DETAILED DESCRIPTION OF PREFERRED EMBODIMENTS OF THE INVENTION

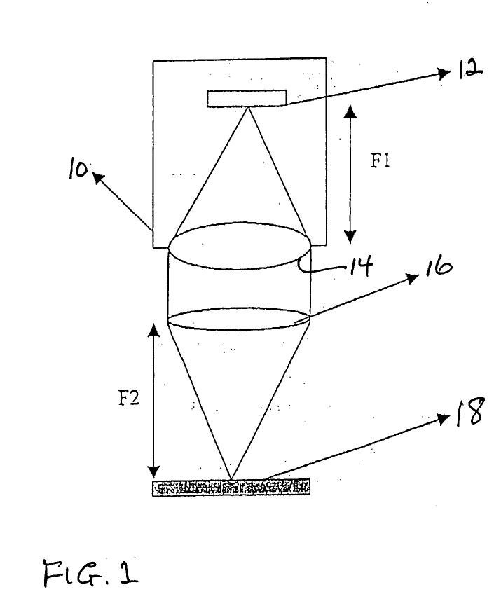

As noted above, FIG. 1 shows schematically an auto focus camera 10 with a focal length of F1, focusing on a CCD or film 12. Immediately in front of, upstream optically, the lens 14 of the auto focus camera 10 is a close up lens 16 with focal length F2 that focuses on an object plane 18.

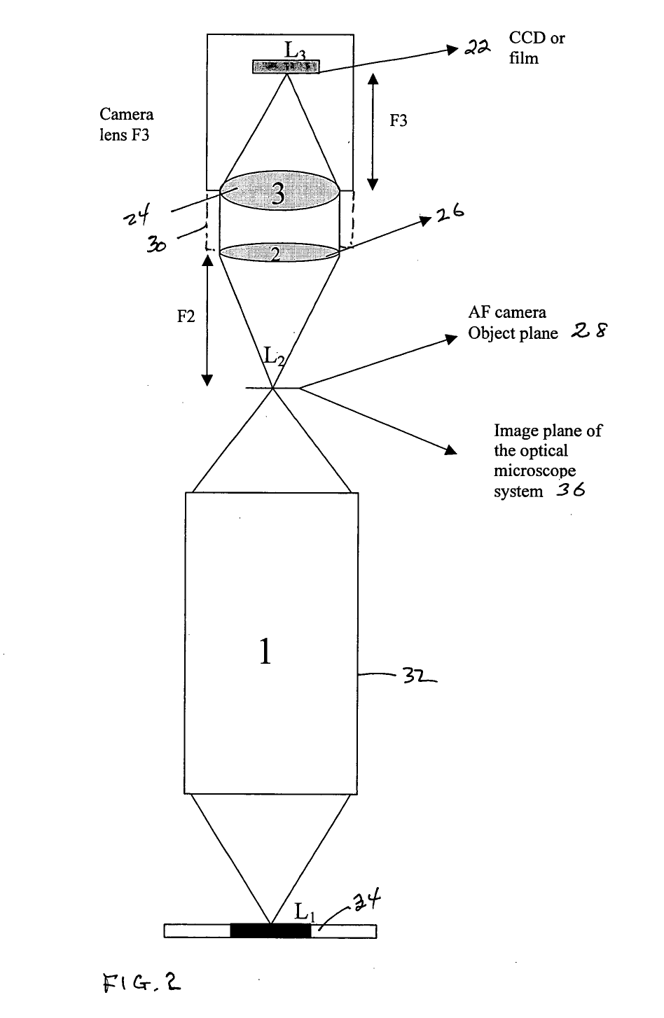

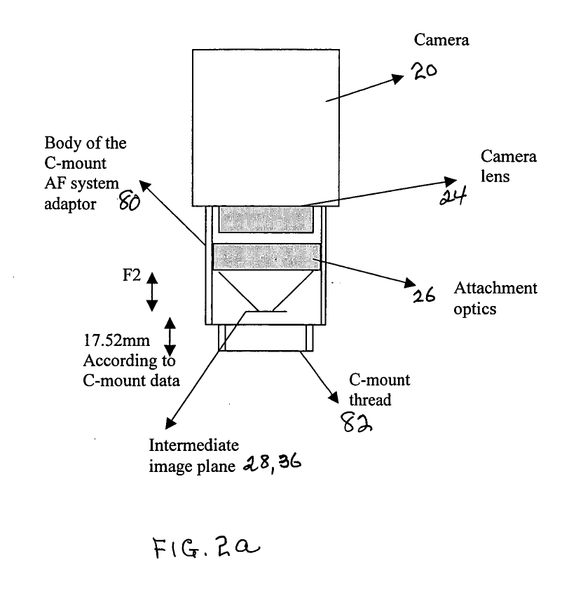

In the present invention, close up lens 26 is built-in directly into auto focus camera 20, in an appropriate juxtaposition with respect to camera lens F3 24, as indicated schematically by the box 30, and as shown schematically in FIG. 2. The lens 14 with focal length F3 focuses on a CCD or film 22. L₃ is the field of view of the auto focus camera 20 at the CCD or film 22. The close up lens or attachment optics F2 26 with a focal length of F2 focuses on the auto focus camera object plane 28. Also, shown schematically in FIG. 2 is an imaging optical system 32, such as a video microscope, video zoom microscope, CCTV lens, etc. that is focused on an object plane 34, at L₁, which is the field of view of the microscope system 1 32. Object plane 34 can be positioned or located at an electrical circuit board undergoing testing and examination for defects. This is mentioned to show the utility of the novel system. The image plane 36 of the imaging optical system 32 is coincident with the object plane 28 of the auto focus camera 20. L₂ is the field of view of the image plane 36 of the microscope system 1, 32. To achieve this coincidence, a C-mount is used that is mounted on the front of the auto focus camera 20 upstream of the close up lens 26 to position or locate the auto focus camera object plane 28 in the proper juxtaposition with respect to the focal distance of lens 26, as shown schematically in FIG. 2a.

As shown in FIG. 2a, the AF camera 20 has a C-mount 30 fixed at the front of the camera 20. The C-mount 30 consists of a main body 80 that encloses the camera lens 24 and the attachment optics 26, which are built in. The intermediate object plane 28, and coincident imaging plane 36 of the microscope system 1, lies inside the body 80 of the C-mount, 17.52 mm from the attachment by the C-mount thread 82.

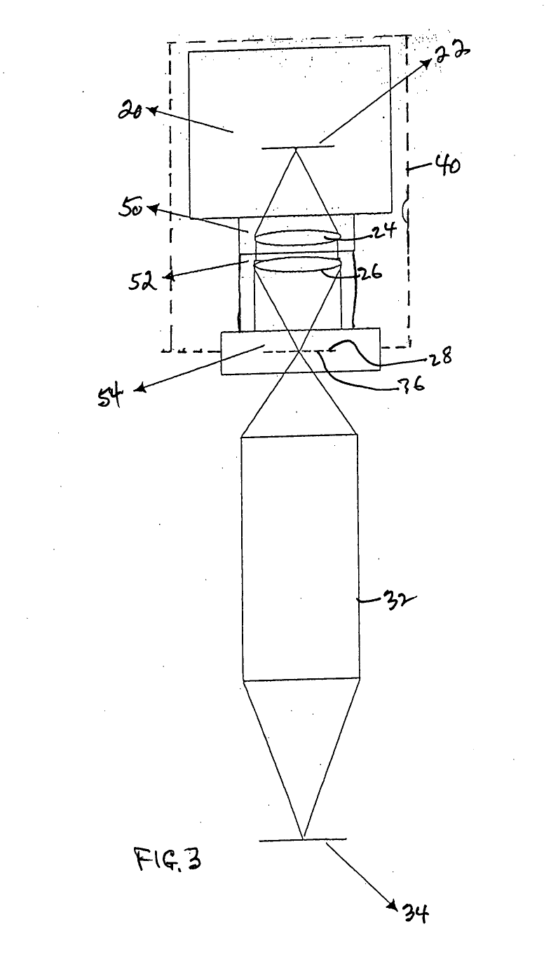

FIG. 3 shows the auto focus camera 20, camera lens 24 and close up lens 26 mounted or bundled together in common as indicated by dotted line box 40 by means of appropriate fittings 50 and 52 on the camera 20 and the lens 24. A C-mount 54 is mounted on the lens 26 to provide the appropriate coupling and juxtaposition with respect to the imaging optical system 32.

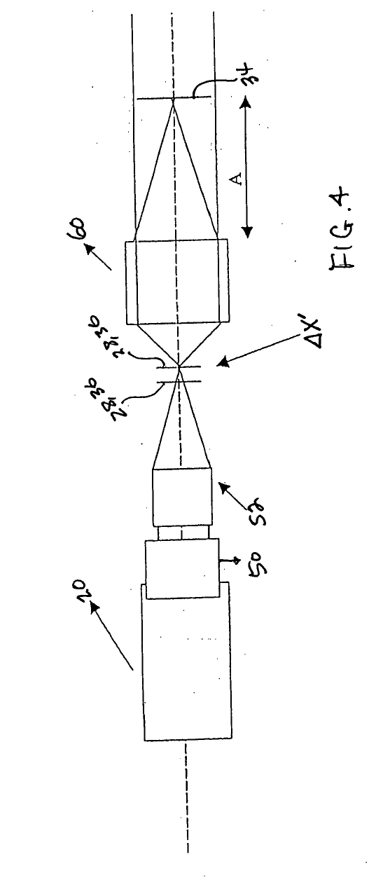

The auto focus compatibility of the novel system of the present invention is illustrated in FIG. 4. As shown, a CCTV lens 60 is able to refocus from infinity to a limited working distance A. The image plane will shift depending on the limits of infinity and the working distance A. Accordingly, by the present invention, adjusting the image plane position with automatically focusing of the camera, enables the image plane to be focused from infinity to a predetermined limited working distance A, and for the object plane of the AF camera to be maintained coincident.

The magnification of the optical system with AF camera can be expressed as
M=L₃/L₁ (1)
L₁ is the Field of view of the optical system and L₃ is the CCD size.

It is possible to calculate quite easily the auto focus range inside an auto focus camera. The minimum working distance of the AF camera is Sₘᵢₙ. The Focal length is F₃.

From this data the focusing travel of the camera lens to CCD can be found by using the well-known Newton lens formula:
F₃²=X·X′ (2)
where X and X′ are the distances of the object and image from the focal point, respectively. Hence
F₃²=(Sₘᵢₙ−F₃)·X′ (3)
and
X′=F₃²/(Sₘᵢₙ−F₃)
And now the depth of field (AF adjustable range) of the inventive system can be found:
DOF=X′·(1/M)²={F₃²/(Sₘᵢₙ−F₃)}*(L₁/L₃)²˜F₃²/L₃² (4)
From formula (4) it is apparent that DOF or AF adjustable range square is proportional to AF camera focal length, and inversely proportional to square of the sensor size.

This means that only AF cameras with small sensor size and long focal length will be useful for microscopy application, and have a suitable AF adjustable range. By the invention, it becomes known that cameras with sensor sizes ¼″ and smaller, and a focal length 60-70 mm and more, will have a reasonable AF range (at least an order of magnitude bigger than DOF of the microscope).

For example, consider two cameras:

Camera 1. F=70 mm, Sₘᵢₙ=800 mm, ¼″ CCD (4 mm diagonal)

Camera 2. F=40 mm, Sₘᵢₙ=1000 mm, ⅓″ CCD (6 mm diagonal)

The Microscopical FOV=1 mm considered in both cases.

DOF₁=(1 mm/4 mm)²*(70 mm)²/(1000−70)=330 um

DOF₂=(1 mm/6 mm)²*(40 mm)²/(1000−40)=46 um

For comparison, the DOF of Navitar Zoom 6000 at the same FOV is 50 um.

The tendency of the camera makers to produce the AF cameras with small sensor sizes and long focal length lenses lends itself to an improved ability to integrate the AF cameras to high magnification microscope systems using the inventive optical system as disclosed and taught herein.

The invention has special applicability to inspections systems, and particularly to electrical circuit inspection systems. Such systems, for example, comprise an automatic optical inspection station 100 that provides an output that is sent to and received by a positioner 120, which suitably positions an electrical circuit 122, such as a printed circuit board under a microscope, see for example, International PCT Published Application No. WO 01/88592 A2. The automatic optical inspection station 100 may be any suitable automatic optical inspection station and, for example, may be a Model PC Micro II commercially available from Orbotech, Ltd. of Yavne, Israel. The positioner 120 may be any suitable positioner and, for example, may be a positioner such as that incorporated in a Model VRS 4M, commercially available from Orbotech, Ltd. of Yavne, Israel. A lens forming part of the microscope 124, receives light from a portion 126 of interest of the printed circuit board, to which an operator's attention is directed by the output from the automatic optical inspection station, which suitably positions that portion in the field of view of the microscope.

In accordance with a preferred embodiment of the present invention, an automatic focus video camera assembly modified with a close up lens 130, as previously described, is positioned downstream of the lens of the microscope 124 so that the image plane of the lens of the microscope and the object plane of the auto focus camera are maintained in coincidence, due to the C-mount 132, as explained previously. A display 140 receives a video output from the camera and displays a magnified image 142 of the portion of the printed circuit board in which a defect is believed to possibly exist so that the operator may decide whether the defect is a real defect or a false alarm.

The camera assembly may be a Sony Model FCB-1X47P, as previously noted, which provides both zoom and automatic focus functionality. The display may be any suitable high-resolution display, such as, a Model PVM-14M4E 14″ Sony color video monitor.

Although the invention has been shown and described in terms of preferred embodiments, nevertheless changes and modifications will be apparent to those skilled in the art. Such changes and modifications, which do not depart from the spirit, scope and contemplation of the present invention, are deemed to fall within the purview of the invention as claimed herein.

1. An optical system comprising an auto focus camera having an object plane, a close up lens coupled to the auto focus camera, a structure coupled to the close up lens and auto focus camera that is capable of being coupled to an imaging optical system having an image plane so that the image plane of the imaging optical system is coincident with the object plane of the auto focus camera.

2. An optical system according to claim 1 wherein the said structure is a C-mount.

3. An optical system according to claim 1 wherein the auto focus camera has a sensor having a size not greater than about ¼″.

4. An optical system according to claim 1 wherein the auto focus camera has a focal length of at least 60 mm.

5. An optical system according to claim 1 wherein the auto focus camera has a focal length of at least 70 mm.

6. An optical system according to claim 1 wherein the auto focus camera has a sensor having a size not greater than about ¼″ and a focal length of at least 60 mm.

7. The combination comprising an auto focus camera having an object plane, a close up lens coupled to the auto focus camera, an imaging optical system having an image plane, a structure coupling the close up lens and auto focus camera to said imaging optical system so that the image plane of the imaging optical system are in coincidence with the object plane of the auto focus camera.

8. An optical system according to claim 7 wherein the said structure is a C-mount.

9. An optical system according to claim 1 wherein the auto focus camera has a sensor having a size not greater than about ¼″.

10. An optical system according to claim 7 wherein the auto focus camera has a focal length of at least 60 mm.

11. An optical system according to claim 7 wherein the auto focus camera has a focal length of at least 70 mm.

12. An optical system according to claim 7 wherein the auto focus camera has a sensor having a size not greater than about ¼″ and a focal length of at least 60 mm.

13. An optical system according to claim 7 wherein the imaging optical system is selected from the class consisting of video microscopes, zoom microscopes and CCTV lens.

14. An inspection system comprising: a lens operative to image light, from a portion of interest in an object undergoing inspection, at an image plane of the lens; an optical assembly including an auto focus camera having an object plane, a close up lens coupled to the auto focus camera, and a structure coupled to the close up lens and auto focus camera; and said structure also being coupled to the lens so that the image plane of the lens is coincident with the object plane of the auto focus camera.

15. An inspection system according to claim 14 wherein the said structure is a C-mount.

16. An inspection system according to claim 14 wherein the auto focus camera has a sensor having a size not greater than about ¼″.

17. An inspection system according to claim 14 wherein the auto focus camera has a focal length of at least 60 mm.

18. An inspection system according to claim 14 wherein the auto focus camera has a focal length of at least 70 mm.

19. An inspection system according to claim 14 wherein the auto focus camera has a sensor having a size not greater than about ¼″ and a focal length of at least 60 mm.

20. An inspection system according to claim 14 wherein the lens is selected from the class consisting of video microscopes, zoom microscopes and CCTV lens.

21. An inspection system according to claim 14 wherein the object undergoing inspection is a printed circuit board.

22. An inspection system according to claim 14 wherein the object of interest is an integrated circuit.

23. An inspection system according to claim 14 wherein the object of interest is a microchip.
